(19) United States
(12) Patent Application Publication
(10) Pub. No.: US 2003/0019599 A1
(43) Pub. Date: Jan. 30, 2003

(54) Sizing dispersion

(76) Inventors: John Nicholass, Frolunda (SE); Fredrik Solhage, Kungalv (SE); Erik Lindgren, Bohus (SE); Sten Frolich, Askim (SE); Michael Persson, Vastra Frolunda (SE); Nicholas Morgan, North Sommerset (GB)

Correspondence Address: LAINIE E. PARKER, AKZO NOBEL INC., 7 LIVINGSTONE AVENUE, DOBBS FERRY, NY, 10522-3408, US

(21) Appl. No.: 10/072,576

(22) Filed: Feb. 8, 2002

Related U.S. Application Data
(63) Continuation-in-part of application No. 09/923,092, filed on Aug. 6, 2001.
(60) Provisional application No. 60/249,365, filed on Nov. 16, 2000.
(60) Provisional application No. 60/223,367, filed on Aug. 7, 2000.
(60) Provisional application No. 60/223,368, filed on Aug. 7, 2000.
(60) Provisional application No. 60/223,369, filed on Aug. 7, 2000.

(30) Foreign Application Priority Data
Nov. 16, 2000 (EP) 00850195.9
Aug. 7, 2000 (EP) 00850135.5
Aug. 7, 2000 (EP) 00850136.3
Aug. 7, 2000 (EP) 00850137.1

(51) Int. Cl. D21H 17/28; D21H 17/00; C08L 3/04; C 09D 1 3/04

(52) U.S. Cl. 162/158; 162/175; 106/209.1; 106/213.1; 106/206.1

(57) ABSTRACT

The present invention relates to an aqueous dispersion of a sizing agent comprising starch having aromatic groups and an anionic polyelectrolyte, wherein the starch has a total amount of amylose of at least about 22% by weight based on total starch.

The present invention is a Continuation In Part Application of U.S. Ser. No. 09/923,092, filed on Aug. 6, 2001 which claims priority of European Patent Application Nos. 00850195.9, filed on Nov. 16, 2000, 00850135.5, filed on Aug. 7, 2000, 00850136.3, filed on Aug. 7, 2000, 00850137.1, filed on Aug. 7, 2000 and U.S. Serial No. 60/249,365, filed on Nov. 16, 2000, No. 60/223,367, filed on Aug. 7, 2000, No. 60/223,368, filed on Aug. 7, 2000 and No. 60/223,369, filed on Aug. 7, 2000.

The present invention refers to an aqueous dispersion of a sizing agent comprising starch having aromatic groups and an anionic polyelectrolyte, wherein the starch has a total amount of amylose of at least 22% by weight based on total starch.

### BACKGROUD

Aqueous dispersions or emulsions of sizing agents are used in papermaking in order to give paper and paper board improved resistance to wetting and penetration by various liquids.

Dispersions of sizing agents generally contain an aqueous phase and finely divided particles or droplets of the sizing agent dispersed therein. The dispersions are usually prepared by homogenizing the sizing agent, water insoluble material in an aqueous phase in the presence of a dispersant using high shear forces and fairly high temperatures. Dispersants conventionally used include anionic, amphoteric and cationic high molecular weight polymers, e.g. lignosulfonates, starches, polyamines, polyamideamines, and vinyl addition polymers. The polymers can be used singly, together or in combination with other compounds to form a dispersant system. Depending on the overall charge of the components of the dispersant system, the size dispersions will be anionic or cationic in nature. The sizing dispersions are usually added to an aqueous suspension containing cellulosic fibres, optional fillers and various additives.

The cellulosic suspension contains a certain amount of non-fibrous material, for example fillers, colloidal substances, charged polymers and various charged contaminants, i.e. anionic trash, electrolytes, charged polymers etc. The charged contaminants has an influence on the sizing efficiency and commonly impairs the sizing performance. High amounts of charged contaminants such as high contents of salts in the suspension renders a suspension which is increasingly difficult to size, i.e. to obtain a paper with satisfactory sizing properties. Other compounds contained in the suspension which deteriorates sizing are various lipophilic wood extractives which may come from recycled fibres and mechanical pulps. An increased amount of added sizing agent often improve sizing, however, leading to higher costs as well an increased accumulation of sizing agents in the white water. The accumulation of non-fibrous material as well as any other components present in the suspension will be even more pronounced in mills where white water is extensively recirculated with the introduction of only low amounts of fresh water into the papermaking process. Thus, it is an objective of the present invention to further improve sizing. Another objective of the present invention is to improve sizing when applying sizes on cellulosic suspensions having high conductivities. Yet another objective of the present invention is to further improve the stability of aqueous dispersions containing aromatic substituted starch, specifically aqueous dispersions containing aromatic substituted starch having a high concentration of sizing agents, e.g. above 25% by weight of sizing agents. Still another objective of the present invention is that the stability of the dispersions are improved, i.e. that improved stability of dispersions is obtained at given concentrations of sizing agent or that the concentration of sizing agent can be increased without substantially impairing the stability. Yet further objectives will appear hereinafter.

### INVENTION

In accordance with the present invention it has been surprisingly been found that improved sizing and/or stability can be obtained with an aqueous dispersion according to the claims. More specifically, the present invention refers to an aqueous dispersion of a sizing agent comprising starch having aromatic groups and an anionic polyelectrolyte, wherein the starch has a total amount of amylose of at least about 22% by weight based on total starch. The present invention further also encompasses a method for the preparation of an aqueous dispersion as well the use of the dispersion as a stock size and surface size.

The sizing agent of the dispersion according to the present invention is suitably any sizing agent known, such as non-cellulose-reactive agents including rosin, e.g. disproportionated rosin, hydrogenated rosin, polymerized rosin, formaldehyde-treated rosin, esterified rosin, fortified rosin and mixtures of such treatments and so treated rosins, fatty acids and derivatives thereof, e.g. fatty acid esters and amides like bis-stearamide, resin and derivatives thereof, e.g. hydrocarbon resins, resin acids, resin acid esters and amides, waxes, e.g. crude and refined paraffin waxes, synthetic waxes, naturally occuring waxes, etc, and/or cellulose-reactive agents. Though, preferably, the sizing agent is a cellulose-reactive sizing agent and suitably the aqueous dispersion is essentially free from rosins and derivatives of rosins. The cellulose-reactive sizing agents comprised in the sizing dispersion can be selected from any cellulose-reactive agents known in the art. Suitably, the sizing agent is selected from the group consisting of hydrophobic ketene dimers, ketene multimers, acid anhydrides, organic isocyanates, carbamoyl chlorides and mixtures thereof, preferably ketene dimers and acid anhydrides, most preferably ketene dimers. Suitable ketene dimers have the general formula (I) below, wherein R¹ and R² represent saturated or unsaturated hydrocarbon groups, usually saturated hydrocarbons, the hydrocarbon groups suitably having from 8 to 36 carbon atoms, usually being straight or branched chain alkyl groups having 12 to 20 carbon atoms, such as hexadecyl and octadecyl groups. The ketene dimers may be liquid at ambient temperature, i.e. at 25° C., suitably at 20° C. Suitable acid anhydrides can be characterised by the general formula (II) below, wherein R³ and R⁴ can be identical or different and represent saturated or unsaturated hydrocarbon groups suitably containing from 8 to 30 carbon atoms, or R³ and R⁴ together with the —C—O—C— moiety can form a 5 to 6 membered ring, optionally being further substituted with hydrocarbon groups containing up to 30 carbon atoms. Examples of acid anhydrides which are used commercially include alkyl and alkenyl succinic anhydrides and particularly isooctadecenyl succinic anhydride.

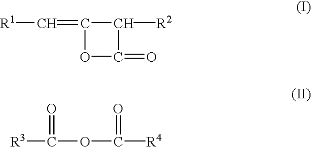

Suitable ketene dimers, acid anhydrides and organic isocyanates include the compounds disclosed in U.S. Pat. No. 4,522,686, which is hereby incorporated herein by reference. Examples of suitable carbamoyl chlorides include those disclosed in U.S. Pat. No. 3,887,427 which is also incorporated herein by reference.

The starch comprised in the dispersion according to the invention refers to starch having aromatic groups, e.g. aralkyl groups such as benzyl and phenylethyl groups, and wherein the starch has a total amount of amylose of at least about 22% by weight based on total starch. Starch contains primarily two components namely amylose and amylopectin. Amylose is an essentially linear polymer whereas amylopectin is a branched polymer having a molecular weight considerably higher than amylose. Depending on the origin of the starch, the amount of amylose comprised in the starch and, furthermore, the degree of polymerisation of the bulk of the amylose will vary considerably. The amylose content and the degree of polymerisation of amylose for inter alia maize and wheat starch is given in J. Swinkels, Starch, 37, 1985. According to this invention, it has been shown that if starch having a total amount of amylose of at least about 22% by weight based on total starch, and an anionic polyelectrolyte are comprised in an aqueous sizing dispersion, the storage stability of the dispersion is significantly improved. Suitably, the starch has a total amount of amylose of from at least about 23% by weight based on total starch up to at least about 26% by weight, such as at least 24% by weight, at least 25% by weight, or at least 26% by weight. The amount of amylose of the starch as defined in the claims refers to the amount of amylose originally present in the starch source, i.e. the amount of amylose contained in the source (e.g. grain sources) prior to any mechanical or chemical treatment. The starch having aromatic groups comprised in the dispersion may also be characterised as a starch where at least 20% by weight of the total amount of amylose, suitably at least 40% by weight, more preferably at least 60% by weight, of the starch has a degree of polymerisation from about 150 up to about 1500, preferably from about 150 up to about 1000. By degree of polymerisation of the amylose is meant the degree of polymerisation prior to any mechanical or chemical treatment of the total starch present in the source. Further appropriate starches can be referred to as aromatic starches having a total content of amylose of at least 22% by weight based on total starch wherein at least 20% by weight of the total amount of amylose has a degree of polymerisation in the range of from about 150 up to about 1500. Starches having an amylose content of at least 22% by weight and/or a high amount of amylose with a degree of polymerisation between 150 to 1500 are suitably obtained from grain sources, exemplified by maize, wheat, rice, barley, sago, sorghum, etc. According to a preferred embodiment the starch having aromatic groups comprised in the dispersion is maize or wheat starch or even more preferably the starch having aromatic groups comprised in the dispersion is maize. According to yet another preferred embodiment the starch having aromatic groups comprises less than 90% by weight of amylopectin.

The starch having aromatic groups is suitably a cationic starch having aromatic groups, the cationic group suitably being tertiary amino groups or, preferably, quaternary ammonium groups. The starch may also contain one or more anionic groups which can be, for example, phosphate, phosphonate, sulphate, sulphonate or carboxylic acid groups and they are preferably phosphate groups. If present, the anionic groups can be native or introduced by means of chemical treatment in conventional manner; native potato starch contains a substantial amount of covalently bound phosphate monoester groups. In amphoteric starches, cationic groups are preferably present in a predominant amount.

The aromatic group of the starch can be attached to a heteroatom, e.g. nitrogen or oxygen, the heteroatom optionally being charged, for example when it is a nitrogen. The aromatic group can also be attached to a group comprising a heteroatom, e.g. amide, ester or ether, which groups can be attached to the polysaccharide backbone(main-chain) of the starch, for example via a chain of atoms. Example of suitable aromatic groups and groups comprising an aromatic group include aryl and aralkyl groups, e.g. phenyl, phenylene, naphthyl, phenylene, xylylene, benzyl and phenylethyl; nitrogen-containing aromatic (aryl) groups, e.g. pyridinium and quinolinium, as well as derivatives of these groups where one or more substituents attached to said aromatic groups can be selected from hydroxyl, halides, e.g. chloride, nitro, and hydrocarbon groups having from 1 to 4 carbon atoms.

Particularly suitable starches comprised in the sizing dispersion include those comprising the general structural formula (I):

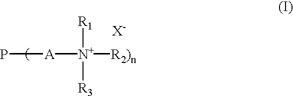

wherein P is a residue of the starch polysaccharide; A is a group attaching N to the polysaccharide residue, suitably a chain of atoms comprising C and H atoms, and optionally O and/or N atoms, usually an alkylene group with from 2 to 18 and suitably 2 to 8 carbon atoms, optionally interrupted or substituted by one or more heteroatoms, e.g. O or N, e.g. an alkyleneoxy group or hydroxy propylene group (—CH₂—CH(OH)—CH₂—); R₁ and R₂ are each H or, preferably, a hydrocarbon group, suitably alkyl, having from 1 to 3 carbon atoms, suitably 1 or 2 carbon atoms; R₃ is an aromatic hydrocarbon group including aralkyl groups, e.g. benzyl and phenylethyl groups; n is an integer from about 2 to about 300,000, suitably from 5 to 200,000 and preferably from 6 to 125,000 or, alternatively, R₁, R₂ and R₃ together with N form a aromatic group containing from 5 to 12 carbon atoms; and X⁻ is an anionic counterion, usually a halide like chloride.

The aromatic group modified cationic or amphoteric starch can have a degree of substitution varying over a wide range; the degree of cationic substitution (DS_{C}) can be from 0.01 to 0.5, suitably from 0.02 to 0.3, preferably from 0.025 to 0.2, the degree of aromatic substitution (DS_{H}) can be from from 0.01 to 0.5, suitably from 0.02 to 0.3, preferably from 0.025 to 0.2, and the degree of anionic substitution (DS_{A}) can be from 0 to 0.2, suitably from 0 to 0.1, preferably from 0 to 0.05.

The starches can be prepared by subjecting a starch to cationic and aromatic modification in known manner using one or more agents containing a cationic group and/or a aromatic group, for example by reacting the agent with the starch in the presence of an alkaline substance such as an alkali metal or alkaline earth metal hydroxide. The starch to be subjected to cationic and aromatic modification can be non-ionic, anionic, amphoteric or cationic. Suitable modifying agents include non-ionic agents such as, for example, aromatic substituted succinic anhydrides; aralkyl halides, e.g. benzyl chloride and benzyl bromide; the reaction products of epichlorohydrin and dialkylamines having at least one substituent comprising an aromatic group as defined above, including 3-dialkylamino-1,2-epoxypropanes; and cationic agents such as, for example, the reaction product of epichlorohydrin and tertiary amines having at least one substituent comprising an aromatic group as defined above, including trialkylamines, alkaryidialkylamines, e.g. dimethylbenzyl-amine; arylamines, e.g. pyridine and quinoline. Suitable cationic agents of this type include 2,3-epoxypropyl trialkylammonium halides and halohydroxypropyl trialkylammonium halides, e.g. N-(3-chloro-2-hydroxypropyl)-N-(hydrophobic alkyl)-N,N-di(lower alkyl)-ammonium chloride and N-glycidyl-N-(hydrophobic alkyl)-N,N-di(lower alkyl)ammonium chloride where the aromatic group is as defined above, notably octyl, decyl and dodecyl, and the lower alkyl is methyl or ethyl; and halohydroxypropyl-N,N-dialkyl-N-alkaryl-ammonium halides and N-glycidyl-N-(alkaryl)-N,N-dialkylammonium chloride, e.g. N-(3-chloro-2-hydroxypropyl)-N-(alkaryl)-N,N-di(lower alkyl)ammonium chloride where the alkaryl and lower alkyl groups are as defined above, particularly N-(3-chloro-2-hydroxypropyl)-N-benzyl-N,N-dimethylammonium chloride; and N-(3-chloro-2-hydroxypropyl) pyridinium chloride. Generally, when using a non-ionic aromatic agent, the starch is suitably rendered cationic by using any of the cationic agents known in the art before or after the hydrophobic modification. Examples of suitable cationic and/or aromatic modifying agents, aromatic group modified starches and methods for their preparation include those described in U.S. Pat. Nos. 4,687,519 and 5,463,127; International Patent Application WO 94/24169, European Patent Application No. 189 935; and S. P. Patel, R. G. Patel and V. S. Patel, Starch/Stärke, 41(1989), No. 5, pp. 192-196, the teachings of which are hereby incorporated herein by reference.

The starch, suitably cationic or amphoteric can be present in the dispersion in amounts varying within wide limits depending on, inter alia, the molecular weight of the compounds, the degree of ionic substitution of the compounds, i.e. the charge density, the desired overall charge of the dispersion and the hydrophobic material used. The starch can be present in an amount of up to 100% by weight, suitably from 0.1 to 35% by weight and preferably from 1 to 30% by weight, based on the hydrophobic material.

The dispersion according to the invention further comprises an anionic polyelectrolyte which suitably is a condensation product of aromatic sulfonic acids and aldehyde. By condensed sulfonate is meant a sulfonate, suitably a polymeric sulfonate, obtained by a condensation reaction. Suitably, the dispersion comprises a condensation product of aromatic sulfonic acids and formaldehyde. The condensation products are generally polyelectrolytes and readily soluble in water. A wide variety of aromatic sulfonic acids can be used such as aromatic sulfonic acids containing one aromatic ring, usually having six carbon atoms, and aromatic sulfonic acids containing two or more aromatic rings having six carbon atoms as well as fused aromatic sulfonic acids. Suitably, the aromatic sulfonic acid is selected from naphthalene, naphthalene reacted with cresol, diphenyl ether, toluene, isopropylbenzene, cresol, phenol. Commonly, the condensation products are formed by reacting the aromatic compound with sulfuric acid thereby forming sulfonic acid and thereafter adding the aldehyde whereby the condensation product is obtained. Occasionally, sodium sulfite may be present during the reaction. According to a preferred embodiment of the present invention the aqueous dispersion comprises a condensation product of naphthalene sulfonic acid and formaldehyde, a condensation polymer commonly referred to as condensated naphthalene sulfonate.

The amount of anionic polyelectrolyte present in the dispersion can vary within wide limits depending on, inter alia, the type of stock, and other compounds present in the aqueous dispersion like stabilisers, dispersion agent and sizing agents. Usually, the dispersion contains from about 1 up to about 20% by weight based on the sizing agent of condensed sulfonate, suitably from about 1 up to about 15% by weight, preferably from about 2 up to about 10% by weight based on the sizing agent.

The dispersions according to the present invention can be anionic or cationic depending on the amount of starch and/or further additives such as dispersing/stabilising agents and protecting compounds contained in the dispersions. By anionic or cationic dispersions is understood that the dispersant is anionic or cationic, i.e. has an overall anionic or cationic charge. The dispersant (system) refers to any compounds present in the dispersion which facilitate the formation of a dispersion/emulsion such as charged polymers (polyelectrolytes) and surfactants. Suitable additives can be any dispersing/stabilising agents and protecting agent known in the art such as non-ionic polymers; cationic, anionic and amphoteric polymers derived from natural sources, i.e. polysaccharides like starch, guar gum, cellulose, chitins, chitosans, glycans, galactans, glucans, xanthan gums, mannans, dextrins, etc., and synthetic organic polymers like condensation products, e.g. anionic polyurethanes and polymeric anionic compounds based on naphthalene, e.g. condensated naphthalene sulfonates, and further vinyl addition polymers formed from monomers with anionic groups, e.g. acrylic acid, methacylic acid, maleic acid, itaconic acid, crotonic acid, vinylsulfonic acid, sulfonated styrene and phosphates of hydroxyalkyl acrylates and methacrylates, optionally copolymerized with non-ionic monomers including acrylamide, alkyl acrylates, styrene and acrylonitrile as well as derivatives of such monomers, vinyl esters, and the like.

Suitably, the aqueous sizing dispersion comprises the sizing agent, preferably a cellulose-reactive sizing agent, in an amount of from about 0.1 to about 60% by weight based on total dispersion, suitably above 20% by weight, preferably above 25% by weight, even more preferably above 30% by weight. Dispersions containing a ketene dimer sizing agent according to the invention may have ketene dimer contents within the range of from 5 to 60% by weight and preferably from about 10 to about 35% by weight. Dispersions, or emulsions, containing an acid anhydride sizing agent according to the invention may have acid anhydride contents within the range of from about 0.1 to about 40% by weight and usually from about 1 to about 25% by weight. Dispersions of non-cellulose-reactive sizing agents generally can have sizing agent contents of from 5 to 50% by weight and preferably from 10 to 35% by weight.

By the “term” dispersion” is meant both dispersion and emulsion depending on the physical state of the sizing agent.

The dispersions according to the invention can be prepared by a method comprising homogenising a sizing agent, suitably under pressure, in the presence of an aqueous phase and a starch preferably at a temperature where the sizing agent is liquid. The obtained aqueous emulsion, which contains droplets of the sizing agent, normally having a size of from 0.1 to 3.5 μm in diameter, is then cooled. Suitable temperatures for ketene dimer sizing agents are from about 55° C. to 95° C. whereas lower temperatures can be employed for acid anhydrides.

The dispersions of the present invention can be used as sizing agents in conventional manner in the production of paper using any type of cellulosic fibres and it can be used both for surface sizing and internal or stock sizing. The term “paper”, as used herein, is meant to include not only paper but all types of cellulose-based products in sheet and web form, including, for example, board and paperboard. The stock contains cellulosic fibres, optionally in combination with mineral fillers, and usually the content of cellulosic fibres is at least 50% by weight, based on dry stock. Examples of mineral fillers of conventional types include kaolin, china clay, titanium dioxide, gypsum, talc and natural and synthetic calcium carbonates such as chalk, ground marble and precipitated calcium carbonate.

The amount of sizing agent added to the stock can be from 0.01 to 5% by weight suitably from 0.05 to 1.0% by weight, based on the dry weight of cellulosic fibres and optional fillers, where the dosage is mainly dependent on the quality of the pulp or paper to be sized, the sizing agent used and the level of sizing desired.

Furthermore, the dispersions of the present invention are preferably used in the manufacture of paper from a stock containing cellulosic fibers, and optional fillers, having a high conductivity. Usually, the conductivity of the stock is at least 0.20 mS/cm, suitably at least 0.5 mS/cm, preferably at least 3.5 mS/cm. Very good sizing results have been observed at conductivity levels above 5.0 mS/cm and even above 7.5 mS/cm. Conductivity can be measured by standard equipment such as, for example a WTW LF 539 instrument supplied by Christian Berner. The values referred to above are suitably determined by measuring the conductivity of the cellulosic suspension that is fed into or present in the headbox of the paper machine or, alternatively, by measuring the conductivity of white water obtained by dewatering the suspension. High conductivity levels mean high contents of salts (electrolytes), where the various salts can be based on mono-, di- and multivalent cations like alkali metals, e.g. Na⁺ and K⁺, alkaline earths, e.g. Ca²⁺ and Mg²⁺, aluminium ions, e.g. Al³⁺, Al(OH)²⁺ and polyaluminium ions, and mono-, di- and multivalent anions like halides, e.g., Cl⁻, sulfates, e.g. SO₄²⁻ and HSO₄⁻, carbonates, e.g. CO₃²⁻ and HCO₃⁻, silicates and lower organic acids. The dispersion is particularly useful in the manufacture of paper from stocks having high contents of salts of di- and multivalent cations, and usually the cation content is at least 200 ppm, suitably at least 300 ppm and preferably at least 400 ppm. The salts can be derived from the cellulosic fibres and fillers used to form the stock, in particular in integrated mills where a concentrated aqueous fibre suspension from the pulp mill normally is mixed with water to form a dilute suspension suitable for paper manufacture in the paper mill. The salt may also be derived from various additives introduced into the stock, from the fresh water supplied to the process, or be added deliberately, etc. Further, the content of salts is usually higher in processes where white water is extensively recirculated, which may lead to considerable accumulation of salts in the water circulating in the process.

1. An aqueous dispersion of a sizing agent comprising starch having aromatic groups and an anionic polyelectrolyte, wherein the starch has a total amount of amylose of at least about 22% by weight based on total starch.

2. An aqueous dispersion according to claim 1, wherein the starch has a total amount of amylose of at least 24% by weight of amylose based on total starch.

3. An aqueous dispersion according to claim 1, wherein at least 20% by weight of the total amount of amylose comprised in the starch has a degree of polymerisation in the range of from 150 up to 1500.

4. An aqueous dispersion according to claim 3, wherein at least 40% by weight of the total amount of amylose comprised in the starch has a degree of polymerisation in the range of from 150 up to 1500.

5. An aqueous dispersion according to claim 1, wherein the starch comprises less than 90% by weight of amylopectin.

6. An aqueous dispersion according to claim 1, wherein the starch is obtained from grain sources.

7. An aqueous dispersion of a sizing agent comprising starch having aromatic groups and an anionic polyelectrolyte, wherein the starch is a maize or wheat starch.

8. An aqueous dispersion according to claim 7, wherein the starch is a maize starch.

9. An aqueous dispersion according to claims 1 or 7, wherein the anionic polyelectrolyte is a condensation product of aromatic sulfonic acids and aldehyde.

10. An aqueous dispersion according to claims 1 or 7, wherein the anionic polyelectrolyte is a condensation product of aromatic sulfonic acids and formaldehyde.

11. An aqueous dispersion according to claims 1 or 7, wherein the anionic polyelectrolyte is a condensation product of naphthalene sulfonic acid and formaldehyde.

12. An aqueous dispersion according to claim 1, wherein the starch has the general structural formula (I): 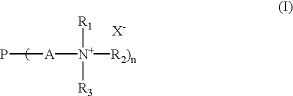
wherein P is a residue of a polysaccharide; A is a chain of atoms comprising C and H atoms attaching N to the polysaccharide residue, R₁ and R₂ are each H or a hydrocarbon group, R₃ is an aromatic hydrocarbon group, n is an integer from 2 up to 300000, and X⁻ is an anionic counter ion.

13. An aqueous dispersion according to claim 12, wherein R₁ and R₂ are alkyl groups having at least 2 carbon atoms, and R₃ is an aralkyl group including benzyl and phenylethyl groups.

14. An aqueous dispersion according to claim 1, wherein the sizing agent is a cellulose-reactive sizing agent.

15. An aqueous dispersion according to claim 14, wherein the sizing agent is a ketene dimer.

16. Method for preparation of an aqueous dispersion by homogenising a sizing agent in the presence of an aqueous phase, starch having aromatic groups wherein the total amount of amylose of the starch is at least 22% by weight based on total starch, an anionic polyelectrolyte and optionally further compounds.

17. Use of an aqueous dispersion according to claim 1 as a stock size or surface size in the production of paper.

18. Use of an aqueous dispersion according to claim 1 as a stock size in the production of paper, wherein the aqueous dispersion is added to a cellulosic suspension having a conductivity of at least 0.5 mS/cm.

19. Use of an aqueous dispersion according to claim 18, wherein the aqueous dispersion is added to a cellulosic suspension having a conductivity of at least 3.5 mS/cm.
